(19) United States
(12) Patent Application Publication
(10) Pub. No.: US 2004/0078828 A1
(43) Pub. Date: Apr. 22, 2004

(54) Recovering timing for television services

(76) Inventors: Travis Randall Parchman, Philadelphia, PA (US); Stephen Jay Kraiman, Warrington, PA (US)

Correspondence Address: FISH & RICHARDSON PC, 225 FRANKLIN ST, BOSTON, MA, 02110, US

(21) Appl. No.: 10/273,525

(22) Filed: Oct. 18, 2002

(51) Int. Cl. H04N 7/173; H04N 11/00; H04N 7/00; H04N 7/16

(52) U.S. Cl. 725/135; 725/136; 348/460; 348/461; 725/90

(57) ABSTRACT

A method for maintaining a time reference for television services includes receiving a transport stream encoding a plurality of television services, and processing at least one of the television services by a first decoder, including receiving time reference data included in the transport stream, estimating a delay in receiving the time reference data, and maintaining the time reference according to the received time reference data and the estimated delay.

### TECHNICAL FIELD

This application relates to recovering timing for television services.

### BACKGROUND

Television systems today provide viewers with hundreds of broadcast channels that include video and audio services. In general a channel includes a number of video and audio services that are encoded in a signal that is transmitted to a user location where it is decoded and presented to the user using equipment (e.g., a “set top box”) at the user location. Typically, this equipment includes dedicated hardware that decodes information in the signal for the video and audio services for presenting to the viewer. Television systems also provide other types of services to viewers, such as Video-on-Demand (VOD) programming which may include various viewer selectable commands. Presenting these other types of services can involve software-based decoding of data in the transmitted signal. Video and audio services, which are typically encapsulated in MPEG (Moving Picture Experts Group) transport streams that are time-synchronized by a program clock reference (PCR) signal, are typically decoded using dedicated hardware.

### SUMMARY

In a general aspect, the invention features an approach to synchronizing television services received by a viewer's equipment with a time reference in the equipment. By determining time delays associated with decoding of some television services and other timing inaccuracies, such as clock time drift, the decoded television services are synchronously presented with other decoded television services.

In one aspect, in general, the invention features a method for maintaining a time reference for television services. The method includes receiving a transport stream encoding a plurality of television services, and processing at least one of the television services by a first decoder, including receiving time reference data included in the transport stream, estimating a delay in receiving the time reference data, and maintaining the time reference according to the received time reference data and the estimated delay.

In another aspect, in general, the invention features an apparatus for maintaining a time reference for television services. The apparatus includes a first decoder for receiving at least one television service from a transport stream encoded with a plurality of television services. The first decoder processes the at least one television service and receives time reference data included the transport stream. The first decoder estimates a delay in receiving the time reference data and maintains the time reference according to the received time reference data and the estimated delay.

In another aspect, in general, the invention features an article including a machine-readable medium which stores executable instructions to maintain a time reference for television services. The instructions cause a machine to receive a transport stream encoding a plurality of television services, and process at least one of the television services by a first decoder. The first decoder includes instructions to cause the machine to receive time reference data included in the transport stream, estimate a delay in receiving the time reference data, and maintain the time reference according to the received time reference data and the estimated delay.

The approach can include one or more of the following features:

A second decoder may process another of the television services, and may maintain a separate time reference, the separate time reference is different from the time reference maintained by the first decoder.

The at least one television service processed by the first decoder and the other television service processed by the second decoded may be combined for displaying to a viewer.

The television service processed by the second decoder may be a video service, and the separate time reference may be maintained by a program clock reference encoded with the video service.

Processing of the television services by the first decoder may include software-based processing.

Estimating the delay may include estimating a delay incurred in the software-based processing of the time reference data in the transport stream.

Maintaining the time reference according to the received time reference data may include determining a time drift.

The time reference data may include a pair of heartbeat packets consecutively positioned in the transport stream.

The approach may have one or more of the following advantages:

Recovering timing for television services provides a timing mechanism so that software-decoded television services which may be presented synchronously with hardware-decoded television services such as video and audio services. For example, sub-pictures, video-highlighting for drawing a viewer's attention, VOD commands, or other television services may be software-decoded and synchronously presented with hardware-decoded video and audio television services to enhance the viewer's experience.

Besides compensating for timing delays caused by software decoding, time drifts between a clock reference generated at a cable head end and a software clock in a set top box connected to a television may be compensated. By compensating for the timing delays and time drifts, software-decoded and hardware-decoded television services may be synchronized to reduce annoyance from unsynchronized services.

In another example, by synchronizing sub-pictures with currently viewed programming, a viewer may have access to different information, such as different viewing aspects related to an individual program scene.

### DESCRIPTION OF DRAWINGS

FIG. 1 is a block diagram of a television service system.

FIG. 1A is a block diagram of a set-top box.

FIG. 2 is a block diagram of a transport stream.

FIG. 3 is a block diagram of a heartbeat packet.

FIG. 4 is a block diagram of heartbeat packets in a transport stream.

FIG. 5 is a flowchart for recovering software clock timing for software-decoded television services.

### DESCRIPTION

Television system 5 provides viewers access to a variety of television services. For example, a viewer can access a particular television channel that provides video and audio services. In addition, the television system 5 provides viewers with video services to enhance television viewing. Enhancements include, outlining video, highlighting portions of a video to draw the viewer's attention, and commands for video-on-demand programming. For presentation, each enhancement is time-synchronized with the video and audio services of the particular channel of interest. For example, to highlight a video object presented on a video service for a particular channel, highlighting graphics are decoded at the viewer's set-top box and synchronously presented with the video object. In order to synchronize the highlighting graphics and the video object, timing information is encoded in the data streams carrying the various services for the channel. In particular, a transport stream that includes the highlighting data and the video and audio services for the particular channel includes timing data that is used for the synchronization.

Set-top boxes typically decode video and audio television services in hardware from the received transport stream. The presentations of these services are synchronized to a system (hardware) clock derived from timing signals embedded in the video or audio service, typically the video service. Other data, such as subpicture data that is also received in the transport stream, is separately decoded by the set-top box, typically in software. The software decoder in some or all set-top boxes often can not access the timing signals embedded in the video service. To synchronize the presentation of hardware and software decoded services, a timing reference is embedded in the transport stream so that a software-based clock in the set-top box can be used to synchronize the presenting of software decoded data with the hardware decoded data. However, the operation of retrieving this timing reference from the transport stream incurs a retrieval time delay that must be compensated. Also as with many clocks, over an operating period the software-based clock can drift in time and this drift is also corrected.

The television system 5 characterizes and compensates for two timing inaccuracies in maintaining the software clock. The first timing inaccuracy is related to time delay due to retrieving the time signals reference from the transport stream that is sent from the cable head end 10. To compensate for this delay the system estimates the time delay incurred in retrieving the timing reference from the transport stream. Two data packets that contain respective time references are consecutively inserted into the transport stream. As each of the data packets are sequentially retrieved from the transport stream a software clock, located in the set top box, is sampled to estimate the retrieval delay. The second timing inaccuracy is related to time drift in the software clock itself. To compensate for this inaccuracy, the system uses the time reference information included in the pair of data packets to estimate and compensate for this drift in the software clock.

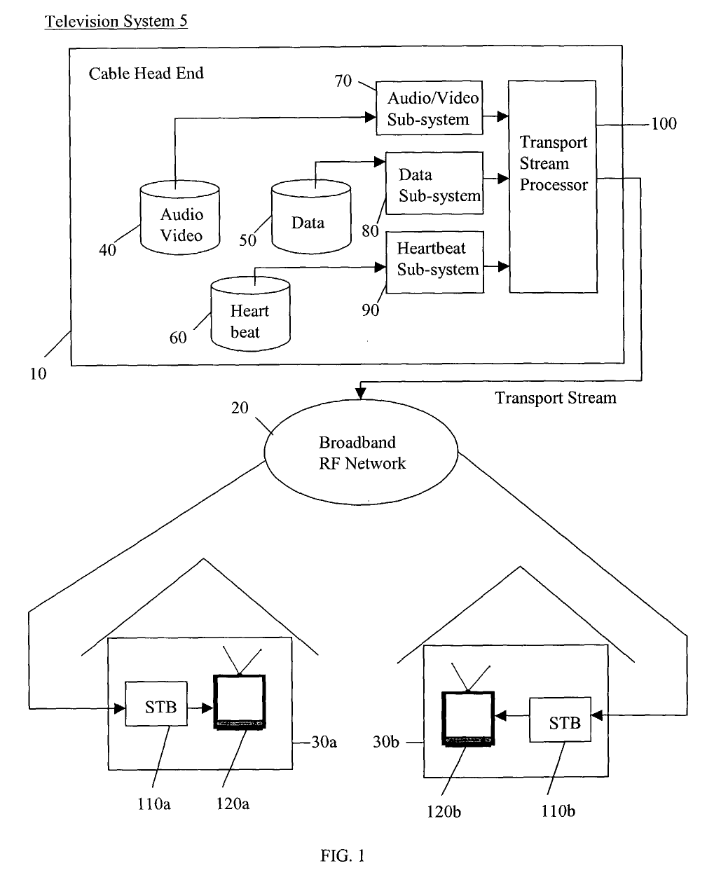

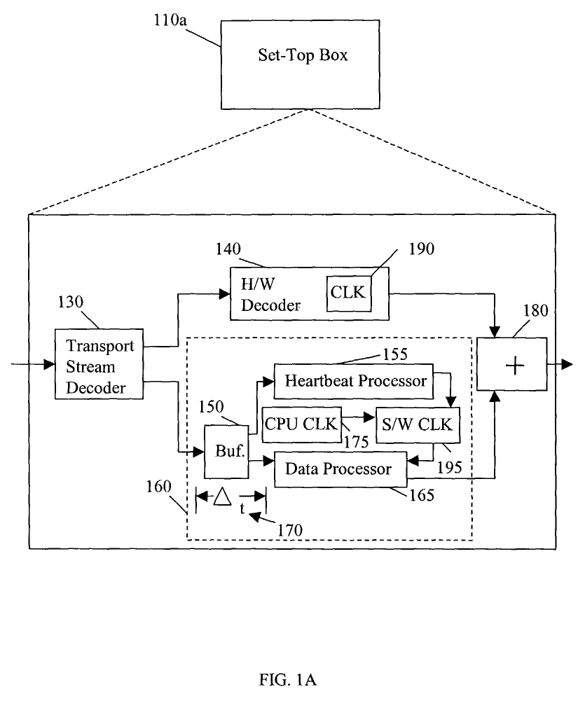

Referring to FIG. 1, a television system 5 includes a cable head end 10 that transmits a transport stream to a broadband RF network 20 that distributes the transport stream to viewer's premises 30a, b. The transport stream contains audio and video services, from an audio/video source 40, a data service, from a data source 50, and a heartbeat service, from a heartbeat service generator 60 that provides the data packets that are inserted in pairs into the transport stream to compensate for the timing inaccuracies. Audio/Video sub-system 70, data sub-system 80, and heartbeat sub-system 90 condition (e.g., select, filter, etc.) the respective services and transfer the services to a transport stream processor 100. The transport stream processor 100 generates the transport stream (i.e., multiplexes the selected services) for transmission on each of a number of different channels to the broadband RF network 20. Also in some arrangements the transport stream is unicast to a single subscriber (e.g., for on-demand viewing). Each viewer residence 30a, b receives the transport stream for a selected channel with a respective set-top-box (STB) 110a, b that decodes the transport stream for the selected channel into the audio/video services, the data service, and the heartbeat service. The set-top boxes 110a,b hardware-decode the audio/video services and software-decode the data service for presenting the services on respective televisions 120a, b. To synchronize the hardware decoded audio and video services, a program clock reference (PCR) is typically inserted into the video services contained in the transport stream and provides a time reference for a clock associated with the hardware decoding. To synchronize the software decoded data service, the heartbeat service is used by the set-top boxes 110a, b to provide a reference time signal to a software based clock also included in the set top boxes.

Referring to FIG. 1A, set-top box 110a (shown in FIG. 1) includes a transport stream decoder 130 that receives the transport streams transmitted from cable head-end 10 (also shown in FIG. 1). Once received, decoder 130 de-multiplexes the transport streams for the tuned channel into individual packets for hardware and software decoding and determines which decoder to send the individual packets for decoding based on a packet identifier in the packet. A hardware decoder 140 receives and decodes the packets that include the video and audio services, while a software decoder 160 decodes data packets. The heartbeat packets are sent from the transport stream decoder 130 to the software decoder 160. The heartbeat packets contain information that can be accessed to provide a time reference to a software clock 195 used by the software decoder 160 which is used as a trigger that releases data for presentation on a television connected to the set top box 110a.

Software decoder 160 first inspects each packet it receives to determine the appropriate software module to process the packet and inserts it into a buffer 150. Heartbeat packets as well as other data packets are queued in the buffer 150. Software decoder 160 invokes appropriate software modules to process packets that are queued in the buffer. These modules include a heartbeat processor 155, as well as a data processor 165. Retrieval time delay 170 is due to the queuing by the buffer 150 and the delay experienced in delivering the packets to either of the software modules 155, 165.

Hardware processor 140 maintains a PCR clock 190 that is based on Program Clock Reference (PCR) data in the video packets it receives. Audio and video data is presented at times specified in the time base of PCR clock 190. Packets arriving at hardware decoder 140 experience relatively little delay and therefore PCR clock 190 essentially tracks the PCR values in packets at the time that they are received by the hardware decoder.

Software decoder 160 maintains a separate software clock 195, which receives an initial time reference from a CPU clock 175, and is compensated for the delay 170 as determined from each pair of received heartbeat packets and for time drift from the information contained in each of the heartbeat packets. Data processor 165, which is passed the data packets sent to the transport stream decoder 130, stores the data packets and determines when information contained data packets is to be passed to a combiner 180 for presentation with the video and audio packets on the television 120a (shown in FIG. 1). For passing the data packets for combining, the data processor 165 also uses the time provided by the software clock 195. In comparison to hardware decoding of the video and audio packets, heartbeat packets that specify the time of the software clock 195 experience significantly longer delays from the time they are passed from transport stream decoder 130 to the time they received by heartbeat processor 155 from the buffer 150. This retrieval time delay 170 may also be variable, for example depending on the load of the software processor that executes commands associated with the software decoder.

Hardware clock 190 and software clock 195 do not necessarily increment in the same time units, or are referenced to the same time origin. The two time bases are associated with a common presentation time relative to the television program or other content transmitted in the transport stream. Therefore correct synchronization of the clocks enables accurately synchronized presentation of audio/video information from the hardware decoder 140 and information from the software decoder 160. Software decoder 160 does not, in general, have access to hardware clock 190 to allow it to synchronize software clock 195 and hardware clock 190 directly. Furthermore, even if once synchronized, the clocks may drift in their absolute time. This time drift induced on the software clock 195 may result from such contributing factors as, the stability and drift (e.g., phase noise) of the CPU clock 175 of the set-top box 110a, which provides the initial timing reference to the software decoding clock 195, and typically operates at a higher frequency than the software clock 195. Time drifts due to the transmission of the transport stream and error correcting at the head end 10 or at the set-top box 110a can also produce time drifts.

Heartbeat packets identify desired values for software clock 195. If possible, it would be desirable to synchronize software clock 195 with the time values specified in heartbeat packets at the time those packets were first received by the software decoder, thereby maintaining software clock 195 in synchronization with hardware clock 190.

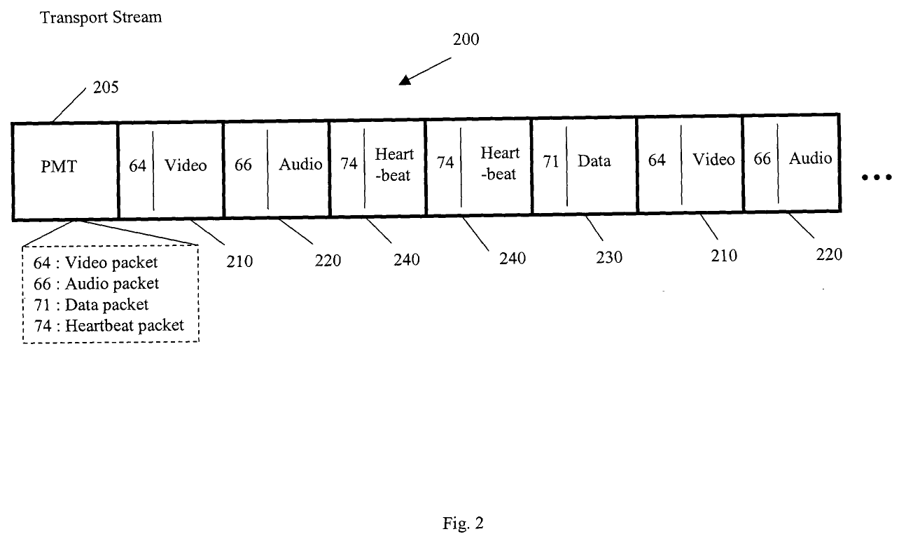

Referring to FIG. 2, an example of a transport stream 200 that is transmitted from the cable head end 10 (shown in FIG. 1) to the user premises 30a,b (shown in FIG. 1) is shown. The transport stream 200 includes packets 210, 220, 230, 240 that are multiplexed by the transport stream processor 100 (shown in FIG. 1) and locally de-multiplexed by the transport stream decoder 130 (shown in FIG. 1A). The transport stream 200 includes video packets 210, which contain video services, audio packets 220, which contain audio services, data packets 230, which contain data services, and heartbeat packets 240. Besides multiplexing the packets 210-240 prior to transmission, the transport stream processor 100 (shown in FIG. 1) also inserts program specific information (PSI) 205 into the transport stream 200 that contains a packet identifier (PID) key for each type of packet. Each packet includes a particular PID unique to each packet type so that as the set-top boxes 110a receive the transport stream the packets are properly passed to the hardware or software decoders 140, 160 (shown in FIG. 1A). For example, video packets are assigned a PID “64”, at the cable head end, and audio packets are assigned a PID “66”. Thus, when the STB's 110a, b receive packets with PID “64” or “66” the packets are passed the hardware decoder 140. When the STB's 110a,b receive packets with a PID of “71” or “74” the packets are passed to the buffer 150 for decoding by the software decoder 160.

For synchronous presenting of the audio and video services stored in audio and video packets 210, 220, hardware clock 190 (shown in FIG. 1A) uses the program clock reference (PCR) that is stored periodically (e.g., 10 PCR's per second) in the audio or video packets 210, 220 (typically only the video packets) as a 43-bit sample of a 27-MHz clock located at the cable head end 10 (shown in FIG. 1). By using the PCR stored within the audio or video packets 210, 220, the hardware clock 190 in the set-top box 110a is synchronized to the PCR references in the hardware-decoded packets at the time they are received by hardware decoder 140. Audio and video information is passed from hardware decoder 140 to combiner 180 according to decode time stamps (DTS) that are relative to PCR references used by the hardware clock 190. However, some STB's, such as the Motorola DCT 2000, do not provide software access to the PCR values received in video and audio packets 210, 220. Thus, software decoder 160 cannot update software clock 195 (shown in FIG. 1A) through access to the PCR-based hardware clock to compensate for time differences between the clocks and maintain synchronous presentation of the data decoded by the software decoder 160 and the video and audio services decoded by the hardware decoder 140.

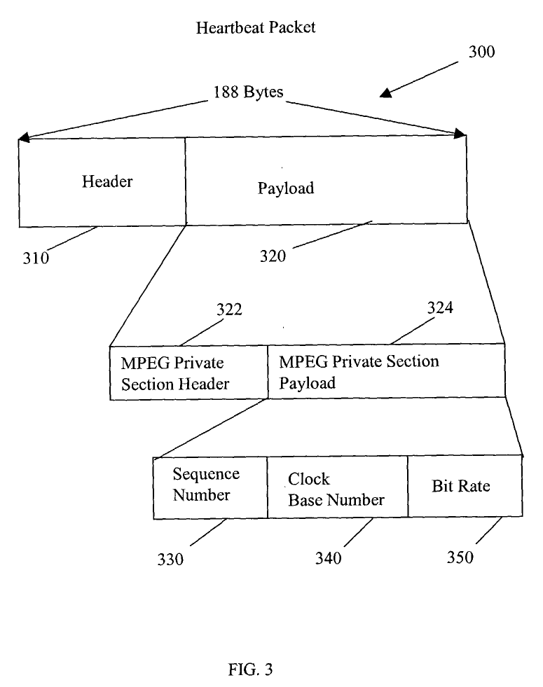

Referring to FIG. 3, a typical heartbeat packet 300 from a transport stream is shown. Each heartbeat packet 300 is 188 bytes in length and separated into a header 310 and a payload 320. The standard MPEG packet header 310 is typically 4 bytes long and includes the packet PID to direct the packet to the software decoder 160 (shown in FIG. 1A). The payload 320 of the packet 300 includes an MPEG private section header 322 and an MPEG private section payload 324 that contains timing information for synchronizing hardware-decoded and software-decoded packets along with information for compensating time drift of the software clock 195 and other system delays. In this implementation the heartbeat MPEG private section payload 324 includes a sequence number 330, a program clock reference base 340 and a bit rate 350. Each of these payload items are unsigned longwords and reside in a portion of the 184-byte payload 320. The sequence number 330 begins with a value of “0” and increases by 1 for each pair of heartbeat packets inserted in the transport stream 200 (shown in FIG. 2). The clock base number 340 is equal to a heartbeat clock reference that is produced at the heartbeat sub-system 90 (shown in FIG. 1) and in some arrangements is referenced to the start of the particular television program or content being transmitted in the transport stream 200 (shown in FIG. 2). In some arrangements the heartbeat clock reference contains a sample of a 10 kHz clock signal produced at the cable head end 10 (shown in FIG. 1). However, in some arrangements the heartbeat clock reference contains samples of a clock signal that operates at a frequency higher or lower than 10 kHz. Typical samples of the program clock reference base 340 range over about a 119-hour time period. Thus, the clock base number 340 may be used to synchronize software-decoded services over a 119 hour time period before resetting. The bit rate 340 contains a constant bit rate of the transport stream in units of bits per second and provides the same value for all of the heartbeat packets inserted into the transport stream since the bit rate of the transport stream is constant.

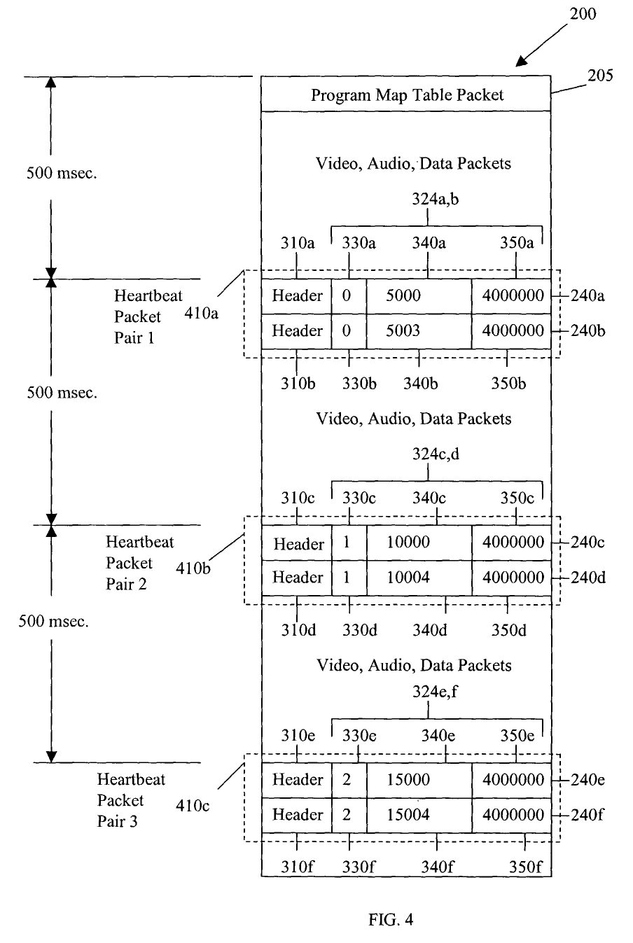

Referring to FIG. 4, the transport stream 200 is extended to show three pairs of heartbeat packets 410a,b,c that are used to determine the time delay 170 (shown in FIG. 1A) and compensate for time drift. In this implementation, each pair of heartbeat packets 410a,b,c are inserted into the transport stream 200 approximately every 500 milliseconds (msec.). The first heartbeat pair 410a is inserted approximately 500 msec. after the program map table 205 and the subsequent pairs 410b,c are inserted approximately 500 msec. apart. Each heartbeat packet pair 410a, b, c includes two heartbeat packets, for example, heartbeat pair 410a includes two heartbeat packets 240a, b, heartbeat pair 410b includes two heartbeat packets 240c, d and heartbeat pair 410c includes heartbeat packets 240e, f. Similar to the heartbeat packet 300 shown in FIG. 3, after the headers 310a-f, each heartbeat packet MPEG private section payload 324a-f includes a sequence number 330a-f that increments for each inserted heartbeat pair 410a, b, c. For example, both heartbeat packets 240a,b for the first heartbeat pair 410a each include a “0” sequence number 330a,b to represent the first inserted heartbeat pair. Similarly, packets 240c and 240d include “1” as a sequence number 330c, d to represent the second inserted heartbeat pair and packets 240e and 240f include “2” as a sequence number 330e, f to represent the third inserted heartbeat packet pair. In another implementation, the sequence number 330a-f may use a 1-based system or any other based number system.

Each heartbeat packet 240a-f also includes a clock base number 340a-f that contains the insertion point of the heartbeat packet based on the 10 kHz clock signal of the heartbeat clock at the cable head end 10 (shown in FIG. 1), and a bit rate number 350a-f that contains the bit rate of the transport stream 200 (typically 3 to 4 Megabits per second). For example, referring to the clock base numbers, packet 240a is inserted into the transport stream 200 500 msec. after the PMT packet 205 and is assigned a clock base number 340a of 5000. Packet 240b is inserted directly after packet 240a and has a clock base number of 5003. After another 500 msec. the heartbeat packet 240c is inserted with a clock base number 340c of 10000, which corresponds to of 1 second after the insertion of the PMT packet 205. Similarly, packet 240d is inserted directly after packet 240c and has a clock base number 340d of 10004. Again, after another 500 msec. the heartbeat packet 240e is inserted with a clock base number 340e of 15000 and packet 240f, directly inserted after packet 240e, has a clock base number 340f of 15004. As mentioned above the bit rate 350a-f of the transport stream 200 is the same for each heartbeat packet 430a-f and in this example each bit rate contains a value for 4 Megabits per second.

Returning to FIG. 1A, heartbeat processor 155 processes heartbeat packets to maintain the software clock 195 in synchronization with the heartbeat clock located at the head end 10 (shown in FIG. 1). Heartbeat processor 155 maintains an estimate for the time delay 170 due to the buffer 150. To compute the time delay 170, as each first heartbeat packet of a heartbeat packet pair is received by the heartbeat processor 155 from the buffer 150, the software clock 195 is sampled for the current time. The software clock 195 is also sampled upon receipt of the second heartbeat packet. The difference of these two time samples provides the estimate of the time delay 170 that then can be applied to the software clock 195. Once the time delay 170 is calculated for one particular heartbeat packet pair (e.g., packet pair 410a shown in FIG. 4), the time delay is averaged with previously calculated time delay estimates from previously received heartbeat packet pairs.

The reason that heartbeat processor 155 uses sequences for two heartbeat packets to estimate delay 170 can be understood as follows. When a first of a pair of heartbeat messages is received, it passes through buffer 150 with a certain delay at which time it is processed by heartbeat processor 155. The second of the pair arrives immediately after the first arrives, while the first is still being processed, and therefore is does not immediately begin processing. After heartbeat processor 155 completes processing of the first heartbeat message, the software decoder 160 begins processing of the second packet, and after a certain delay the heartbeat processor 155 begins processing of the second heartbeat packet. Therefore, if the delay is Δt, and the first packet arrived at time t₀, then the heartbeat processor 155 begins processing of the first heartbeat message at time t₀+Δt, and assuming negligible processing time by heartbeat processor 155, processing of the second heart beat packet begins at t₀+2Δt. Therefore, the different between the times that the heartbeat processor 155 begins processing each of the two heartbeat messages is the heartbeat processor's estimate of the delay for this pair of heartbeat messages.

Using this delay estimate, based on the samples from the software clock 195 to represent the arrival times of the heartbeat packets at the heartbeat processor 155, the heartbeat processor can calculate the time delay in terms of clock cycles or in terms of the transit time from the head end in clock cycles. To determine the time delay 170 in clock cycles, for use in compensating the software clock 195, the difference of the arrival times and clock reference bases are used:

Delay(Clock Cycles)=(Arrival Time 2−Arrival Time 1)−(Clock Base 2−Clock Base 1)

Referring to FIG. 4, as an example, the clock reference bases 340a, b that are stored in heartbeat packet pair 1 410a can be used in the equation above to determine the number of clock cycles in the delay. To represent the arrival times, in this particular example, the software clock 195 is sampled at time 16414 when the first heartbeat packet 240a arrives at the heartbeat processor 155 and the software clock 195 is sampled at 16419 when the second heartbeat packet 240b arrives. Using the equation above, the number of clock cycles in the delay is:

$$\begin{matrix}Delay in clock cycles = ( 16419 - 16414 ) - ( 5003 - 5000 ) \\ = 5 - 3 \\ = 2 clock cycles .\end{matrix}$$

To determine the transit time delay from the head end 10 (shown in FIG. 1) in comparison to the hardware decoded services, the transmission bit rate 350a is used along with the clock rate of the software clock 195. Similar to determining the delay in clock cycles, the difference of the arrival time of the first heartbeat packet 240a and the arrival time of the second heartbeat packet 240b is used along with the bit length of each heartbeat packet:

Delay in clock cycles=(Arrival Time 2−Arrival Time 1)−(Heartbeat packet length in bytes*8 bits/byte*Clock rate)/(Transmission bit rate)

Again, using the information in FIG. 4 and same the clock samples representing the arrival times for heartbeat packet 1 240a and packet 2 240b, the transit delay time in clock cycles from the head end is:

$$\begin{matrix}Delay in clock cycles = ( 16419 - 16414 ) - ( 188 * 8 * 10 , 000 ) / ( 4 , 000 , 000 ) \\ = 1.24 clock cycles\end{matrix}$$

After the software clock 195 has been compensated for the time delay 170 (shown in FIG. 1A), the time drift that is experienced in the software clock 195 is compensated by the clock reference bases 340a-f (shown in FIG. 4) that are included in each heartbeat packet 240a-f (also shown in FIG. 4). When heartbeat processor 155 receives a heartbeat message, which contains a desired value (i.e., the clock base number) for software clock 195, it uses the time sampled of the software clock 195 to determine the difference between this sampled time and the clock reference base number of the received heartbeat packet. If the clock has not drifted then the calculated difference between the clock reference base number and the sample of the software clock is zero. Once the difference value is calculated, the heartbeat processor 155 updates the software clock 195 according to this calculated difference value to compensate for some or all of the time drift. Also the heartbeat processor 155 optionally averages the calculated drift values prior to applying them to the software clock 195.

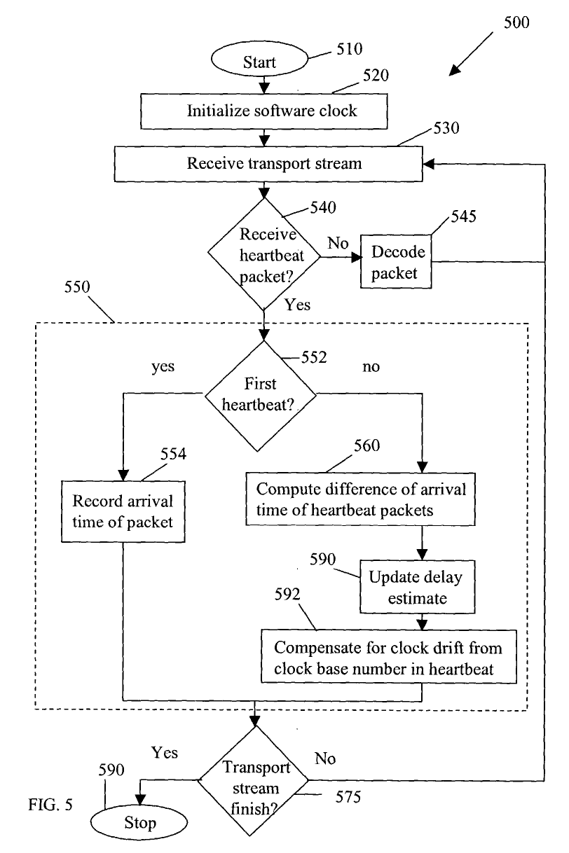

Referring to FIG. 5 a procedure 500 for using heartbeat packets to compensate for time delay due to software decoding and clock time drift is shown. After starting 510, the procedure 500 initializes 520 the software clock 195 (shown in FIG. 1A) with the CPU clock 175 (also shown in FIG. 1A). In one example, the system clock may be initialized to provide an unsigned 32-bit time value, in increments of 1/10,000 of a second, and corresponds to the start of a received transport stream. As mentioned the CPU clock 175 typically has a faster clock rate than the software clock 195. Once the software clock 195 is initialized 520, a transport stream containing, for example, video, audio, data and heartbeat packets is received 530 by the STB 110a. After receiving 530 the transport stream, the procedure 500 determines 540 if the currently received packet of the transport stream is a heartbeat packet or not. If the packet is a not a heartbeat packet, the procedure 500 transfers 545 the packet for proper hardware decoding or other software decoding. If a heartbeat packet is received, the procedure 500 then uses the heartbeat packet for time compensating 550.

Time compensating 550 includes first determining 552 if the received heartbeat packet is the first of a heartbeat packet pair. If this heartbeat is the first of a pair, the time the packet arrived at (i.e., was first handled by) the heartbeat processor 155 (shown in FIG. 1A) is recorded 554. If this is the second of a pair the difference between the arrival times of the two heartbeats is computed 560. This difference is used to update the estimate of delay 170 using an averaging procedure 570 and apply the average to the software clock 195 (also shown in FIG. 1A). Once the delay 170 is compensated, the procedure 500 compensates for clock drift based on the value of the clock reference base in the first, second or both of the received heartbeat packets 592.

Referring briefly to FIG. 4, when the first heartbeat packet 240a is received by the heartbeat processor 155 (shown in FIG. 1A), the clock base number 340a (5000) plus the current estimate of delay 170 is compared to the current time of the software clock 195 to determine if the software clock has drifted in time. Similarly, as the other heartbeat packets 240b-f are received and software-decoded, the clock base numbers contained in each respective heartbeat packet can be compared to the software clock 195 to determine if the clock as drifted in time. After recording the arrival time of the first heartbeat packet 554 or updating the delay estimate 590, the procedure 500 determines 575 if the transport stream is completed. If the transport stream transmission has not completed, the procedure 500 returns to receive 530 more packets from the transport stream. If the transmission of the transport stream is complete the procedure 500 stops 590.

Rather than compensating the software clock 195 (shown in FIG. 1A) for both time drift and delays from software decoding, either compensation may be applied individually. Thus, the software clock 195 located, for example in the STB 110a may be compensated for time drift or for time delay due to software decoding.

Also, besides averaging the time drift and the timing delay due to software-decoding, individual time drifts and timing delays, determined from individual heartbeat packets, may be applied to the software clock. In conjunction with FIG. 4, the heartbeat packet pairs 410a-c were inserted into the transport stream 200 in 500 msec. intervals. In other implementations, the heartbeat packet pairs 410a-c may be separated by shorter or longer time intervals within the transport stream 200. In some implementations, the heartbeat processor 155 (shown in FIG. 1A) can disregard calculated delay values that exceed a threshold and are determined to be erroneous.

A variety of data services can be synchronized with audio and video services using the approach described above. Examples of data services include closed caption services that require presentation of text or other graphics during a program. Another example is a menu service that requires presentation of software decoded or generated graphical images (e.g., buttons, highlights, etc.) during presentation of a video service, for example, that provides background pictures.

The software clock 195 (shown in FIG. 1A) as mentioned uses an underlying hardware clock (the CPU clock), which typically operates at a faster rate than the software clock, as a time reference. The software clock 195 also, for example, can be set to time zero at the start of a transmitted program, and increment at 10 kHz. Data services can also include information that identifies when the services should be presented based on this clock, which is for example, in units of 100 microseconds from the start of the movie program. The hardware clock 190 (also shown in FIG. 1A) does not necessarily, or even typically, have a zero-origin at the start of a program. As described above, the PCR clock increments at 27 MHz. However, because the software clock is synchronized based on the location of the heartbeat packets in the stream, the hardware and software clocks do not have to use the same origin or time increments. Furthermore, in the delivery process through a television system, the time origin of the PCR clock for a program can be modified (“re-stamped”), for example, due to multiplexing, demultiplexing, or splicing transport streams, and therefore at the time of authoring a data service, the PCR at the time the service will be presented is unpredictable. If a data service were to reference the PCR clock, then the references would not necessarily be updated when the PCR clock itself was modified.

The approach described can be used in other contexts in which a delay must be compensated to maintain a software clock. For example, audio and video services may be decoded in software and the PCR-based clock is then maintained using estimated retrieval delays. Also, other sequences of timing-related packets than pairs of heartbeat packets may be inserted into a transport stream based on the characteristics of the packet delivery and decoding process to estimate a fixed or variable delay.

Also in some implementations, time delay 170 (shown FIG. 1A) can be determined after a single program transport stream (SPTS) containing video, audio and heartbeat packets is multiplexed into a multiprogram transport stream that includes multiple SPTS's. For example, a SPTS with a 3 Mega bit per second bit rate can be multiplexed with nine other SPTS's (each with respective bit rates of 3 Mega bit per second) into a multiprogram transport stream that contains the ten SPTS's and has a bit rate of 30 Mega bit per second. In this particular example, 9 packets would be inserted between each packet of each SPTS. So, 9 packets are inserted between two heartbeat packets of one particular transport stream. As mentioned the multiprogram transport stream is delivered at a bit rate of 30 Mbps, but since only 1 of 10 packets is from one individual SPTS, the packets are delivered at 1/10th of 30 Mbps, or 3 Mbps, the original rate of the individual SPTS's. So while the multiplexed transport stream has a bit rate of 30 Mega bits per second, the effective bit rate between the heartbeat packets is equivalent to inserting no packets between two heartbeat packets in a SPTS with a bit rate of 3 Mega bits per second.

A number of embodiments of the invention have been described. Nevertheless, it will be understood that various modifications may be made without departing from the spirit and scope of the invention. Accordingly, other embodiments are within the scope of the following claims.

What is claimed is:

1. A method for maintaining a time reference for television services comprising:
receiving a transport stream encoding a plurality of television services; and
processing at least one of the television services by a first decoder, including
receiving time reference data included in the transport stream,
estimating a delay in receiving the time reference data, and
maintaining the time reference according to the received time reference data and the estimated delay.

2. The method of claim 1 further comprising:
processing another of the television services by a second decoder;
maintaining a separate time reference by the second decoder, the separate time reference is different from the time reference maintained by the first decoder.

3. The method of claim 2 further comprising combining the at least one television service processed by the first decoder and the other television service processed by the second decoded for displaying to a viewer.

4. The method of claim 1 wherein the television service processed by the second decoder is a video service, and maintaining the separate time reference by a program clock reference encoded with the video service.

5. The method of claim 1 wherein processing television services by the first decoder includes software-based processing.

6. The method of claim 5 wherein estimating the delay includes estimating a delay incurred in the software-based processing of the time reference data in the transport stream.

7. The method of claim 1 wherein maintaining the time reference according to the received time reference data includes determining a time drift.

8. The method of claim 1 wherein the time reference data includes a pair of heartbeat packets consecutively positioned in the transport stream.

9. An apparatus for maintaining a time reference for television services comprising:
a first decoder for receiving at least one television service from a transport stream encoded with a plurality of television services, the first decoder processes the at least one television service and receives time reference data included the transport stream; the first decoder estimates a delay in receiving the time reference data and maintains the time reference according to the received time reference data and the estimated delay.

10. The apparatus of claim 9 further comprising:
a second decoder for processing another of the television services; the second decoder maintains a separate time reference different from the time reference maintained by the first decoder.

11. The apparatus of claim 10 further comprising:
a combiner to combine the at least one television service processed by the first decoder and the other television service processed by the second decoder for displaying to a viewer.

12. The apparatus of claim 9 wherein the television service processed in the second decoder is a video service, the separate time reference is maintained by a program clock reference encoded with the video service.

13. The apparatus of claim 9 wherein the first decoder uses software-based processing on the at least one television services processed in the first decoder.

14. The apparatus of claim 13 wherein estimating the delay includes estimating a delay incurred in the software-based processing of the time reference data in the transport stream.

15. The apparatus of claim 9 wherein maintaining the time reference according to the received time reference data includes determining a time drift.

16. The apparatus of claim 9 wherein the time reference data includes a pair of heartbeat packets consecutively positioned in the transport stream.

17. An article comprising a machine-readable medium which stores executable instructions to maintain a time reference for television services, the instructions causing a machine to:
receive a transport stream encoding a plurality of television services; and
process at least one of the television services by a first decoder including
instructions causing the machine to,
receive time reference data included in the transport stream,
estimate a delay in receiving the time reference data, and
maintain the time reference according to the received time reference data and the estimated delay.

18. The article of claim 17 further comprising instructions to:
process another of the television services in a second decoder; and
maintain a separate time reference by the second decoder, the separate time reference is different from the time reference maintained by the first decoder.

19. The article of claim 18 further comprising instructions to:
combine the at least one of the television services processed by the first decoder and the other television service processed by the second decoder for displaying to a viewer.

20. The article of claim 17 wherein the television service processed in the second decoder is a video service, and maintaining the separate time reference by a program clock reference encoded with the video service.

21. The article of claim 17 wherein to process television services in the first decoder includes software-based processing.

22. The article of claim 21 wherein to estimate the delay includes estimating a delay incurred in the software-based processing of the time reference data in the transport stream.

23. The article of claim 17 wherein to maintain the time reference according to the received time reference data includes determining a time drift.

24. The article of claim 23 wherein the time reference data includes a pair of heartbeat packets consecutively positioned in the transport stream.
